(19) United States
(12) Patent Application Publication
(10) Pub. No.: US 2016/0312003 A1
(43) Pub. Date: Oct. 27, 2016

(54) SUCCINATE ESTER FOR USE AS PLASTICIZER AND BIODEGRADABLE RESINS COMPRISING THIS SUCCINATE ESTER

(71) Applicant: PROVIRON HOLDING N.V., Hemiksem (BE)

(72) Inventors: José Vanheule, Hemiksem (BE); Johan Declerck, Hemiksem (BE); Sonja Stankovic, Hemiksem (BE)

(21) Appl. No.: 15/104,651

(22) PCT Filed: Dec. 4, 2014
(86) PCT No.: PCT/EP2014/025022

§ 371 Date: Jun. 15, 2016

(30) Foreign Application Priority Data
Dec. 20, 2013 (BE) 2013/0862
Dec. 20, 2013 (BE) 2013/0863

(51) Int. Cl. C08K 5/11

(52) U.S. Cl. CPC C08K 5/11

(57) ABSTRACT

The present invention refers to the use of bis(ethoxylated alkyl)succinate, preferably bis(butyldiglycol)succinate, as plasticizer in biodegradable resins, more in particular, in resins comprising a homo- or co-polymer of polylactic acid and/or a polybutylene succinate. The invention also refers to a biodegradable resin composition, more in particular, comprising homo- or co-polymers of polylactic acid and comprising bis(ethoxylated alkyl)succinate, preferably bis(butyldiglycol)succinate as plasticizer.

### FIELD OF THE INVENTION

The present invention relates to a new composition of a succinate ester that can be used as plasticizer in biodegradable resins, in particular, resins based on or containing polylactic acid. More in particular, the invention refers to an ester obtained by esterification of succinic acid with an ethoxylated alcohol. In a preferred embodiment of the invention, use is made of butoxyethoxyethanol. These products have quite specific properties with respect to the compatibility with the biodegradable polymer, and they are of, at least partial, biological origin. In this way, this invention helps to enhance the ecological durability of the final application.

### BACKGROUND OF THE INVENTION

Nowadays, petroleum-based polymers are widely used as traditional plastics in, for example, packaging and other consumables. These products, however, have various disadvantages, in particular, the accumulation of non-biodegradable plastics in the environment and the use of non-renewable raw materials. For this reason, during recent years, there is a growing interest in so-called biodegradable polymers as alternative solution for the traditional petroleum-based polymers. Biodegradable polymers are polymers obtained from molecules of vegetable origin. These biodegradable polymers shall be referred to, hereinafter, as biopolymers.

Among such biopolymers, the importance of polylactic acid is steadily growing. One of the driving forces of this invention is the fact that the production cost of L-lactic acid has been substantially reduced by high-volume production of crops such as corn, grains and potatoes . . . Plastics or resins such as polylactic acid manufactured on the basis of these natural raw materials are characterized by a high strength and good transparency.

A drawback of polylactic acid for use as plastic in industrial applications is, however, the low impact resistance, as well as the brittleness and resulting lack of flexibility. These material features are caused, among others, by a high crystallinity and a rigid molecular structure of this polymer. Nevertheless, amorphous formulations of polylactic acid are also available; these, however, are equally brittle and hard. This disadvantage limits its use in a great number of applications, in particular, for use in film or packaging material on a large scale.

It is known in the art to compensate for this drawback by softening polylactic plastics or resins by incorporation of plasticizers, by applying co-polymerization, or by blending polylactic acid with more soft polymers.

The use of plasticizers in resins to increase their flexibility is a well-known method, and is not particularly limited to biopolymers. By the use of plasticizers the possibilities and applications for these polymers are substantially increased. Plasticizers are usually available in liquid form and can be used to process resins in various technical processes, such as injection molding, thermoforming, blown film and cast film extrusion, rotational molding, fibre spinning, filament processing. The plasticizers can be optimized for use in various polymers. More in particular, the polarity of a plasticizer can match the polarity of the polymer or polymer composition, so as to obtain an efficient interaction between these components, which results in a high plasticizing efficiency and a low migration of the plasticizer. Plasticizers are used in various polymers, among which the most important are: polyvinylchloride, polyamide, polar rubbers, polyurethane, and also biopolymers like polylactic acid.

As described in European patent EP 2 202 267 B1, filed by Daihachi Chemical Industry Co., Osaka, Japan, published Dec. 7, 2011, a known disadvantage of adding plasticizers is their tendency to migrate to the surface of the plastic. Various disadvantages result therefrom: the color and the surface appearance is modified, the transparancy of the plastic is reduced, and the fragility and brittleness of the plastic increase over time due to reduction of the plasticizing effect by the migration of the plasticizer from the bulk of the plastic to the surface (see e.g. paragraphs 4 and 5 of the text). This patent describes the use of mixed esters of a.o. succinic acid to minimize the migration from the PLA-polymer. The ester form of this patent, however, is not mentioned, contrary to other symmetric esters, such as butyldiglycol adipate. The properties of the latter compound, however, are less beneficial.

The scientific article published in SEI Technical Review, Number 66, April 2008, pages 50-54 entitled “ Development of Elastic Polylactic Acid material Using Electron Beam Radiation”, by Shinichi Kanazawa, describes the crystalline behavior of polylactic acid and the ‘bleeding out’ of a plasticizer added to this compound. It confirms that, on the longer term, the polylactic acid based resin becomes brittle and hard.

The article does not specify plasticizers used. It discloses an electron-beam method to counter such bleeding-out phenomenon. Usually 10 to 30% by weight of the plasticizer should be added to the plastic so as to sufficiently reduce the glass transition temperature, usually to about room temperature.

Various plasticizers have been proposed in the state of the art to deal with this problem.

Japanese patent application No. 2000-198908, for example, discloses the use of acetyl tributyl citrate as plasticizer in polylactic acid.

In U.S. Pat. No. 8,232,354 B2, filed by Kao Corp. Tokyo, Japan, a method is described for the manufacture of plastic compounds on the basis of polylactic acid, wherein a polycarbodiimide cross-linker has been added. The results of this compound in terms of plasticizing effects however were unsatisfactory.

U.S. Pat. No. 7,842,761, in the name of Lapol LLC, Santa Barbara, Calif., USA, describes a biological plasticizer for biopolymers such as polylactic acid, comprising a polyester plasticizing unit.

Column 1, lines 52 and following disclose the three basic techniques for plasticizing polymers of the polylactic acid type: addition of a plasticizer, co-polymerization and blending of flexible polymers.

More in particular, in this text, the drawbacks of the first two techniques are described.

U.S. Pat. No. 8,158,731 in the name of Hallstar Innovations Corp., Chicago, USA describes polymer blends comprising on the one part a biopolymer and on the other part an aliphatic polyester. The polyester is derived from repeating units of a dicarboxylic acid and an aliphatic diol.

As biopolymer, polylactic acid has been mentioned, for example on column 1, line 41. As dicarboxylic acids, for example, succinic acid and adipic acid have been mentioned (column 2, lines 13-14).

In the international patent application published as WO 2013/148255 in the name of 3M Innovative Properties Company, Saint Paul, Minn., USA, all claims are directed to citrate esters, comprising (amongst others) tetrahydrofurfuryl groups and a hydrogen or acyl group.

Reference is made e.g. to claim 13.

These plasticizers have been developed for use in ‘suitable polymeric materials’, see e.g. page 8, line 31, specifically mentioning polylactic acid. On page 8 the inventors extensively describe polylactic acid and on page 10 some commercial suppliers of this compound are set forth.

Page 7, lines 26-28 disclose that as well the citric acid as the tetrahydrofurfuryl alcohol may be produced by renewable raw materials. References to the preparation method for tetrahydrofurfuryl are set forth in the following lines.

Page 8 lines 20 and following describe the requirement of compatibility of the plasticizer with the polymer to be softened.

A suggestion is being made to the fact that the solubility nature of both compounds should be close to each other for a plasticizer to continue fulfilling its plasticizing function in the polymer.

Tri(alkyl)citrate has been mentioned on page 8, line 29.

Page 14, lines 23-29 describe the migration issue of the more traditional plasticizers when used in polylactic acid, and the fact that over time polylactic acid becomes brittle by the migration of the traditional plasticizers to the surface of the material (poor age stability).

So as to solve the problem of the migration of the plasticizer from the bulk of the polymer to the surface, a mixture could be used comprising plasticizers with quite different chemical structures. In such a case, however, other drawbacks appear: for example difficulties related to an appropriate and homogeneous mixing of these compounds in the biodegradable plastic, or their inherent incompatibility with the biopolymer.

The plasticizers known to be used in polymers such as polyvinylchloride do not necessarily act as plasticizers in polylactic acid in an acceptable manner: a minimal compatibility should be present between the plasticizer and the polymer to be plasticized. For this purpose, there should be a match between the chemical structure of the plasticizer and the polymer.

### PROBLEM AND AIM OF THE INVENTION

The aim of the present invention is to solve the problems and overcome the above-mentioned drawbacks.

More in particular, the aim of the invention is to provide plasticizers that can be used to reduce the glass transition temperature Tg of biopolymers, more in particular, of biopolymers based on polylactic acid, to increase the elongation at break of these compounds, and to increase their flexibility.

The benefit resulting from the realization of this aim is to provide plasticized biodegradable resins, showing characteristics comparable to more traditional resins. Thanks to these characteristics, traditional resins may be effectively replaced on the market by such plasticized biodegradable resins.

Examples of these traditional plastics to be replaced comprise: polyethylene (PE), polypropylene (PP), thermoplastic elastomers, acrylonitrile-butadiene-styrene copolymers (ABS), polystyrene (PS), poly-ethylene-terephthalate (PET).

As mentioned above, although the use of plasticizers in biopolymers, and more specifically in polylactic acid may substantially enhance the flexibility, most of the plasticizers are characterized by a migration phenomenon to the surface of the plasticized biopolymer. This, in turn, results in a slowly increasing brittleness. A more specific aim of the inventors is the development of new plasticizers with an increased compatibility and a low migration. By fulfilling such more specific aim, namely, the increase of the stability of plasticized biopolymers over time, and more in particular polylactic based polymers, biopolymers might become eligible for use in various new fields of application.

### DESCRIPTION OF THE INVENTION

The invention relates to the use of bis(ethoxylated alkyl)succinate as plasticizer in biodegradable polymers so as to increase the properties and processability of these biopolymers.

According to a preferred embodiment, the invention relates to the use of the above-mentioned succinate compound, wherein alkyl is either ethyl, propyl or butyl. According to a further preferred embodiment, the degree of ethoxylation of the succinate compound is at least two.

According to a further preferred embodiment, the succinate compound is selected from the following list: bis(butyldiglycol)succinate, bis(butyltriglycol)succinate, bis(butyltetraglycol)succinate.

According to the invention, a mixture of succinates as mentioned earlier can be used as plasticizers for biodegradable aliphatic polyester resins.

Furthermore, the invention relates to biodegradable resin compositions manufactured on the basis of biodegradable polymers and comprising bis(ethoxylated alkyl)succinate. According to more preferred embodiments of the invention, the resin compositions comprise the above-described, more preferred, succinate compounds. The addition of the latter compound modifies the mechanical properties such as storage modulus and elongation at break.

In particular, the invention relates to biodegradable resin compositions comprising (i) a biodegradable aliphatic polyester resin and (ii) a plasticizer comprising bis(ethoxylated alkyl)succinate, more preferably, the above-described succinates, and still more preferably, bis(butyldiglycol)succinate.

According to a preferred embodiment, the invention relates to the biodegradable aforementioned resin composition, wherein the biodegradable aliphatic polyester resin is at least one member selected from the group consisting of resins obtained by condensation of hydroxycarboxylic acid(s) and resins obtained by condensation of aliphatic dicarboxylic acid(s) and aliphatic diol(s).

According to a further preferred embodiment of the biodegradable resin composition in this invention, the biodegradable aliphatic polyester resin comprises a homo- or copolymer of a polylactic acid and/or a polybutylene succinate.

The invention further relates to a method for plasticizing a biodegradable aliphatic polyester resin, the method comprising addition of bis(ethoxylated alkyl)succinate to a biodegradable aliphatic polyester resin, more preferably, the above-described succinates, and still more preferably, bis(butyldiglycol)succinate.

According to a preferred embodiment of this method, the biodegradable aliphatic polyester resin comprises a polylactic acid and/or a polybutylene succinate.

In the description set forth hereinafter, the invention will be described in detail with respect to a preferred embodiment of the succinate, namely bis(butyldiglycol)succinate.

For the person skilled in the art, it is clear that this detailed description mutatis mutandis is applicable to any other succinate compound comprised within the more general compound bis(ethoxylated alkyl)succinate.

In the context of the present invention, the term bis(butyldiglycol)succinate also may be denoted as bis(butoxyethoxyethyl)succinate.

It may be obtained by the esterification of the corresponding dicarboxylic acid, succinic acid, or the corresponding anhydride form, with the corresponding alcohol, butyldiglycol. The preparation of this compound is set forth hereinafter in more detail.

The chemical formula of bis(butyldiglycol)succinate is as follows:

CH₃—CH₂—CH₂—CH₂—O—CH₂—CH₂—O—CH₂—CH₂—O—CO—CH₂—CH₂—CO—O—CH₂—CH₂—O—CH₂—CH₂—O—CH₂—CH₂—CH₂—CH₃

### DETAILED DESCRIPTION OF THE INVENTION

According to the invention, bis(ethoxylated alkyl)succinate, and more preferably bis(butyldiglycol)succinate, is used as plasticizer in biodegradable resins, more in particular, in biodegradable aliphatic polyester resins, thereby resulting in a remarkably low volatility and an excellent thermal stability.

The term biodegradable aliphatic polyester resins as used in the context of the present invention should be understood as comprising either the homopolymer or a copolymer of polylactic acid and/or a polybutylene succinate.

The term biodegradable polymer is further clarified in this specification under the heading: application.

Whereas the use of symmetric esters of aliphatic carboxylic acids as plasticizer for biopolymers is known, the inventors have surprisingly found that the use of bis(butyldiglycol)succinate as plasticizer in biopolymers, and in particular in polylactic acid, results in a reduced weight loss during the thermal stability tests at increased temperature (at 60° C.). Furthermore, the biopolymers are characterized by a higher degree of crystallinity and a remarkably increased elongation at break. The most surprising effect of the compound according to the invention is a substantively lower volatility in polylactic acid as compared to, for example, a symmetrical ester of a carboxylic acid, such as di(butoxyethoxyethyl)adipate in spite of a higher vapor pressure of this compound in pure form. Besides, the use of these compounds as plasticizer in, for example, polylactic acid during the processing to finished products, such as films, results in clearly improved properties such as, the absence of smell and the absence of a greasy appearance of the film surface. Without being bound to a scientific explanation, the present inventors do believe that this surprising effect is caused by an increased compatibility of these plasticizers with the hydrophilic, polar polylactic acid.

Application:

The succinate compound, according to the invention, is particularly suitable as plasticizer in biopolymers.

The term biopolymers in the context of the present invention should be understood as comprising polymers that are manufactured in a synthetic manner from monomers of biological origin. More in particular, the succinate, according to the invention, can be used as plasticizer in such biodegradable polymers on the basis of aliphatic polyesters, as well homo- as copolyesters. Still more in particular, the succinate can be used as plasticizer in biopolymers on the basis of polylactic acid (PLA).

The term polylactic acid, as used in the context of the present invention, relates to a polymer or copolymer comprising at least 50 mol % of lactic acid monomer units. Examples of such polylactic acids comprise, but are not restricted to:

(a) a homopolymer of polylactic acid, (b) a copolymer of lactic acid with one or more aliphatic hydroxycarbon acids, different from lactic acid, (c) a copolymer of lactic acid with an aliphatic polyhydric alcohol and an aliphatic polycarbon acid, (d) a copolymer of lactic acid with an aliphatic polycarbon acid, (e) a copolymer of lactic acid with an aliphatic polyhydric alcohol, and (f) a mixture of two or more of (a)-(e) as above mentioned. Examples of lactic acid comprise L-lactic acid, D-lactic acid, a cyclic dimer hereof (L-lactide, D-lactide or DL-lactide) and mixtures hereof. Examples of the hydroxycarboxylic acid usable in the above-mentioned copolymers (b) and (f) comprise, but are not restricted to, for example: glycolic acid, hydroxybutyric acid, hydroxyvaleric acid, hydroxyhexanoic acid and hydroxyheptanoic acid, as well as combinations hereof.

Furthermore, the biodegradable or bio-renewable thermoplastic materials wherein the succinate according to the invention might be used as plasticizer, may consist of a single thermoplastic material such as a polymer (for example polylactic acid alone), but they might also consist of a mixture of polylactic acid with at least one additional thermoplastic material. In such a preferred embodiment, the biodegradable or bio-renewable thermoplastic material may comprise a blend or mixture of polylactic acid with one or more aliphatic polyesters or copolyesters like polybutylene succinate, polyhydroxy alkanoates (PHA), starch, cellulose or another polysaccharide or combinations hereof.

In still another preferred embodiment the biodegradable or bio-renewable material may comprise a blend or mixture of polylactic acid with at least one aliphatic polyester (e.g. polybutylene succinate) or copolyester, a mixture of polylactic acid with at least one polyhydroxy alkanoate (PHA), or a blend of polylactic acid with another biopolymer such as starch, cellulose or another polysaccharide. In a still more preferred embodiment, the biodegradable or bio-renewable thermoplastic material may comprise a mixture of polylactic acid, at least one PHA and at least one starch. In some embodiments, the thermoplastic material may be present in about 5 to about 95% by weight, calculated on the basis of the total weight of the composition. In some embodiments, the amount of polylactic acid, as compared to the total amount of thermoplastic material in the composition, is comprised between approximately 15 to approximately 100% by weight, and, in other embodiments, is comprised between approximately 30 to approximately 100% by weight calculated in relation to the total weight of thermoplastic material.

Mode of Preparation:

The ester and its use as plasticizer, according to the invention, may be manufactured as described below.

As a first step, the alcohol is introduced in a reactor, and heated to approx. 90° C. Subsequently, the succinic acid or the corresponding anhydride is added such that the ratio of acid to alcohol is approx. 1:2. The use of an excess amount of alcohol and the use of a dehydrating agent or azeotropic agent may be of advantage to finish the reaction. As a catalyst, the use can be made of a strong acid, such as sulfuric acid. The reaction is considered to be finished when no water is formed any more. After neutralization of the catalyst, the possible excess amount of alcohol is removed by distillation. The mixture may be washed to remove possible impurities. As a supplementary step, the ester can be discolored by means of discoloration techniques known per se, such as: the use of active carbon, oxidation with hydrogen peroxide, hydrogenation with hydrogen, . . . Finally, the product is dried by heating at increased temperature (80 up to 150° C.) under vacuum.

The ester, according to the invention, is in particular suitable for use as plasticizer in various polymers, and more specifically in biopolymers. Examples of polymers wherein the ester can be used as plasticizer are aliphatic polyester resins (for example polylactic acid and polybutylene succinate), cellulose esters, polyvinylchloride, polyvinylbutyral, polar rubbers, polyurethanes and acrylate polymers such as poly(methyl methacrylate).

Aliphatic polyesters may be produced according to the dehydration-polycondensation reaction of one or more aliphatic hydroxycarboxylic acids or their dehydrated cyclic analogues (lactones and lactides). Examples of hydroxycarboxylic acids are L-lactic acid, D-lactic acid, glycolic acid, hydroxy-butyric acid, hydroxy-valeric acid, hydroxy-pentanoic acid, hydroxy-hexanoic acid, hydroxy-heptanoic acid, . . .

According to an alternative method the aliphatic polyesters may be manufactured by a dehydration-polycondensation reaction of a mixture comprising an aliphatic polycarboxylic acid and an aliphatic diol, such as polybutylene succinate. Examples of such compounds are mentioned in the already cited PCT publication WO 2013/148255.

The term polylactic acid, as used in the context of the present invention, relates to a homopolymer of lactic acid or a copolymer of lactic acid with a hydroxycarboxylic acid or a polymer composition containing either the homopolymer of lactic acid or a copolymer of lactic acid with a hydroxycarboxylic acid. By the presence of a chiral core in lactic acid, the molecular structure of lactic acid in the polylactic acid can be either L-lactic acid or D-lactic acid, or a mixture of both in various possible concentrations. The choice of the cyclic monomer used in the polymerization reaction to produce polylactic acid determines, together with the choice of the plasticizer, the concentration of the plasticizer in the polymer and the processing conditions for incorporation of the plasticizer in the polymer, the final properties of the polymer. For the polymerization reaction to polylactic acid, use is, preferably, made of lactide, i.e., the cyclic monomer comprising two molecules of lactic acid that are dehydrated. This lactide can be either L,L-lactide (2 molecules of L-lactic acid), as well as D,D-lactide (2 molecules of D-lactic acid) or meso-lactide (1 molecule of L-lactic acid and 1 molecule of D-lactic acid).

The average molecular weight of the polylactic acid is, preferably, from about 10 000 up to 1 000 000, more preferably, from about 30 000 to about 600 000, and still more preferably, from about 50 000 to about 400 000. Polylactic acid, with an average molecular weight between the above-mentioned limits, has usually a sufficient mechanical strength and a good processability.

Examples of commercially available polylactic acids are “Ingeo” of Natureworks,“Purasorb” from Corbion Purac, “Lacty”, marketed by Shimadzu Corp., “Lacea”, marketed by Mitsui Chemicals Inc., “Terramac”, marketed by Unitika Ltd., “eco-PLA” marketed by Cargill-Dow LLC, USA, “Ecologe”, marketed by Mitsubishi Plastics Inc.

When used as plasticizer, the ester according to the present invention usually functions as primary plasticizer. According to a more specific embodiment, other plasticizers may be added to the biopolymer, whereby the ester, according to the invention, may then function either as primary or secondary plasticizer.

According to a preferred embodiment of the present invention, the amount of polylactic acid in the plastic composition is at least 50% of the total weight of the composition, and according to a still more preferred embodiment, at least 60%.

So as to obtain a sufficient level of mechanical strength, impact resistance and flexibility, the amount of ester in the plastic composition, according to the present invention, amounts to 2 to 50%, more preferably from 2 to 20%. In more durable consumption products such as the housing or casing of electrical appliances and automotive parts, the amount should preferably not exceed 25%. In products that require a high degree of flexibility such as films for use in agricultural applications or for packaging, the amounts are preferably comprised between 5 and 40%.

The resin composition, according to this invention, may, apart from the plasticizer, comprise one or more other ingredients such as, for example, inorganic fillers and silicates, such as talc, china clay, montmorillonite, silica, magnesium oxide, titanium oxide, calcium carbonate, magnesium hydroxide, fiber glass, carbon fibers, graphite powder, etc.

The resin composition according to this invention may apart from the plasticizer also comprise one or more other ingredients added so as to optimize the resin composition in view of the anticipated application. These ingredients may comprise flame retardants, hydrolysis-retardants, a lubricant, an antistatic agent, antifogging agents, light stabilizers, UV-absorbers, fungicidal additives, antimicrobial additives, foaming agents, . . .

Preparation of the Resin Composition:

An amount of polylactic acid Ingeo 2003D (extrusion quality) (hereinafter referred to as PLA 2003D) or Ingeo 3251D (injection molding quality) (hereinafter referred to as PLA 3251D) grains were dried during 24 hours in an oven at 70° C. and subsequently introduced in a Brabender-mixing device. The amount of PLA was chosen so as to obtain an amount of 55 g of resin material. PLA was then heated at a temperature of around 190° C. and stirred at a speed of 50 revolutions per minute. After 5 minutes the plasticizer was added, and the mixture was further stirred for a total duration of 15 minutes. Afterwards, the mixture was cooled. Preparation of films (10 cm*10 cm*450 um) on the basis of PLA 2003D (the preparation of films on the basis of PLA 3251D occurs in a similar manner) was conducted by means of an Agila PE20 hydraulic press. 7.5 g of the resin composition containing the ester compound, as previously described, was pressed at a temperature of 170° C. The contact time was initially 4 minutes, followed by 3 minutes 20 seconds at 10 bar and 2 minutes 30 seconds at 150 bar with two degassing cycles; after this, cooling with water took place at 50 bar for the period of 3 minutes.

Evaluation of the Ester Mixture as Plasticizer for PLA by Means of DSC:

Analysis Conditions:
Equilibration at −20° C. for 2 min;
First heating cycle from −20° C. to 200° C. at a speed of 10° C./min;
Cooling from 200° C. to −40° C. at a speed of 10° C./min;
Second heating from −40° C. to 200° C. at a speed of 10° C./min.

Evaluation of the films took place on the basis of a visual inspection, odor, greasy appearance of the film surface, weight loss at 60° C. during a period of 6 weeks and determination of the storage modulus according to DMA analysis (Dynamic Mechanical Analysis).

The results are displayed in the tables below for each of the following compounds:

ATBC=acetyl-tri-butyl-citrate

DBEEA=bis(butyldiglycol)adipate (di-butoxyethoxyethyl-adipate)

DBEESu=bis(butyldiglycol)succinate (di-butoxyethoxyethyl-succinate)

DTHFSu=ditetrahydrofurfurylsuccinate

Results of the evaluation of the films based on PLA 2003D:

TABLE 1
PLA 2003D

| | | Tg | Crystallinity | Modulus |
|---|---|---|---|---|
| plasticizer | % | (° C.) | % | at 30° C. |
| Blanco | 0 | 61.8 | 0 | 2952 |
| ATBC | 15 | 27.3 | 1.4 | 1764 |
| DBEEA | 15 | 30.3 | 5.3 | 1134 |
| DBEESu | 15 | 30.0 | 19.5 | 1282 |
| DTHFSu | 15 | 30.2 | 0.6 | 1962 |

TABLE 2
PLA 2003D

| | | Weight loss in % at 60° C. | | | |
|---|---|---|---|---|---|
| plasticizer | % | 7 days | 3 weeks | 6 weeks | remarks |
| ATBC | 15 | 1.22 | 1.7 | 4.94 | greasy (exudation) |
| DBEEA | 15 | 1.64 | 1.85 | 2.14 | greasy (exudation) |
| DBEESu | 15 | 0.22 | 0.26 | 0.74 | good |
| DTHFSu | 15 | 0.26 | 0.64 | 5.54 | Sample broken |

Results of the evaluation of the films based on PLA 3251D:

TABLE 3
PLA 3251D

| | | Tg | crystallinity | Modulus | elongation |
|---|---|---|---|---|---|
| plasticizer | % | (° C.) | % | 7 d 50° C. | at break |
| Blanco | 0 | 58.9 | 7.4 | 2719 | 5% |
| ATBC | 15 | 33.9 | 38.0 | 1463 | 32% |
| DBEEA | 15 | 20.1 | 52.4 | 1246 | 29% |
| DBEESu | 15 | 18.8 | 51.8 | 940 | 89% |
| DTHFSu | 15 | 29.3 | 34.3 | 1132 | 42% |

TABLE 4
PLA 3251D

| | | Weight loss in % at 60° C. | | | |
|---|---|---|---|---|---|
| plasticizer | % | 7 days | 3 weeks | 6 weeks | remark |
| ATBC | 15 | 1.85 | 2.25 | 7.07 | Greasy (exudation) |
| DBEEA | 15 | 2.29 | 2.55 | 2.97 | Greasy and flexible |
| DBEESu | 15 | 1.41 | 1.61 | 2.21 | Good & flexible |
| DTHFSu | 15 | 0.46 | 0.85 | 5.37 | Sample broken |

The above-described results of the tests performed on the film samples show that, as well on the PLA 2003D as on the PLA 3251D, the ester, according to the invention, results in notably better results for elongation at break and for storage modulus.

1. Use of bis(butyldiglycol)succinate as a plasticizer in an amount of 2 to 20% by weight in a biodegradable aliphatic polyester resin comprising a homo- or copolymer of polylactic acid, having a degree of crystallinity of at least 19.5%.

2-6. (canceled)

7. A plasticizer for a biodegradable aliphatic polyester resin comprising a homo- or copolymer of polylactic acid, having a degree of crystallinity of at least 19.5%, the plasticizer comprising bis(butyldiglycol)succinate in an amount of 2 to 20% by weight with respect to the resin.

8-10. (canceled)

11. A biodegradable resin composition having a degree of crystallinity of at least 19.5% containing (i) a homo- or copolymer of a polyactic acid and (ii) a plasticizer comprising bis(butyldiglycol)succinate in an amount of 2 to 20% by weight with respect to the resin.

12-15. (canceled)
